(19) United States
(12) Patent Application Publication
(10) Pub. No.: US 2018/0028407 A1
(43) Pub. Date: Feb. 1, 2018

(54) TABLET CASSETTE

(71) Applicant: TOSHO, INC., Tokyo (JP)

(72) Inventor: Yoshihito Omura, Tokyo (JP)

(21) Appl. No.: 15/548,234

(22) PCT Filed: Feb. 4, 2016
(86) PCT No.: PCT/JP2016/053358

§ 371 Date: Aug. 2, 2017

(30) Foreign Application Priority Data
Feb. 5, 2015 (JP) 2015-021533

(51) Int. Cl. A61J 7/00; B65D 83/04

(52) U.S. Cl. CPC A61J 7/0076; B65D 83/0481

(57) ABSTRACT

A tablet cassette includes a tablet container, a first rotor, a rotating shaft, and a second rotor. The tablet container has a tablet receiving space for randomly receiving the tablets and an outlet port for discharging the tablets. At the peripheral edge portion of the first rotor, tablet receiving portions are provided side by side for temporarily receiving the tablets. The first rotor is disposed on an inner bottom portion of the tablet receiving space and is rotated by the rotating shaft. The second rotor has one or more through holes. The second rotor partitions the tablet receiving space into a lower receiving space and an upper receiving space. The rotating shaft causes the second rotor to axially rotate. The first rotor and the second rotor are inclined to align the outlet port with an uppermost position of the rotating first rotor.

### TECHNICAL FIELD

The present invention relates to a tablet cassette working as a portion to be driven in a tablet feeder for automated dispensation of tablets in a hospital or pharmacy.

### BACKGROUND ART

As typically disclosed in Patent Documents 1 to 3 (refer to FIG. 5), a widely-used conventional tablet feeder includes a driving portion 10′ fixed to a drawer rack or the like in a tablet dispensing apparatus for power supply and control, and a tablet cassette 20′ detachably mounted on the driving portion 10′ for facilitating replenishment of tablets. The tablet feeder stores a number of tablets 4′ in the tablet cassette 20′ at random and is configured to feed out tablets 4′ one by one from the tablet cassette 20′ by intermittently or continuously operating the driving portion 10′ as needed.

In such tablet feeder (10′, 20′), the tablet cassette 20′ includes a tablet container 21′, a rotor 23′, a rotating shaft 27′, and a partition plate 29′. The tablet container 21′ stores a number of tablets 4′ in its internal space and has a lid 22′ to be opened when replenishing the tablets 4′. The rotor 23′ is mounted on an inner bottom portion of the internal space of the tablet container 21′ so as to be axially rotatable. The rotating shaft 27′ is disposed in the center of a lower end of the rotor 23′ and is operable to transmit a movement of axial rotation of a driving shaft 11′ of the driving portion 10′ to the rotor 23′ when the tablet cassette 20′ is mounted on the driving portion 10′ to cause the rotating shaft 27′ to be engaged with the driving shaft 11′. An outlet port 28′ is formed to penetrate a bottom plate of the tablet container 21′ that defines an lower end of an annular gap 24′ between the tablet container 21′ and the rotor 23′. The partition plate 29′ is disposed to be opposed to the outlet port 28′ and to partition a part of an upper portion of the annular gap 24′.

A plurality of blade-shaped partition walls 25′ are provided at an equidistant pitch on an outer peripheral surface of the rotor 23′ to project into the annular gap 24′ where the tablets 4′ are lined up in order to partition the annular gap 24′ into a plurality of spaces each sized for one tablet. Two adjacent partition walls 25′, 25′ form a tablet receiving portion 26′ for receiving a tablet. Each tablet receiving portion 26′ receives one tablet 4′ or a plurality of tablets in a vertical row that fall down from the upper portion of the rotor 23′. Here, positional adjustment of the partition plate 29′ such as the height of the mounting position of the partition plate has been performed before the partition plate 29′ is fixed such that the partition plates 29′ can partition the lowermost tablet 4′ from other upper tablets 4′ in each tablet receiving portion 26′.

While the tablet container 21′ and the rotor 23′ are made of a hard material, the partition plate 29′ is made of a softer material than metal or hard material not to damage the tablets 4′. For facilitating the positional adjustment such as the height of the mounting position of the partition plate, the partition plate 29′ is mounted by means of fitting in optionally selected holes formed at appropriate heights rather than using screws.

As with a tablet cassette disclosed, for example, in Patent Document 4, a double fall-down prevention member made of readily deformable elastic or flexible material is employed in place of the partition plate 29′ mentioned above in order to readily deal with irregularly shaped or halved tablets as regularly shaped tablets can readily be dealt with. Such double fall-down prevention member is supported by bearings and disposed over the outlet port 28′ or above the partition walls 25′.

Such tablet cassette is intended to be used for tablets, not powder medicines. Typically, a tablet cassette is used for tablets shaped in circular disc like illustrated disc-shaped tablets 4′. A tablet cassette is often used for tablets shaped in regular polygon or cylindrical capsules.

In addition to tablets of regular shape such as a circle, a globe, a regular polygon and a regular polyhedron, a tablet cassette is sometimes used for tablets of irregular shape such as a diamond, spindle-shaped tablets having an expanded central portion, and halved tablets prepared by cutting a complete tablet for doses of less than one tablet.

### PRIOR ART DOCUMENTS

### Patent Documents

Patent Document 1: JP 2002-153541 A

Patent Document 2: JP 2002-154637 A

Patent Document 3: JP 2012-120719 A

Patent Document 4: JP 2015-012893 A

### SUMMARY OF THE INVENTION

### Technical Problem

In above-mentioned conventional tablet cassettes, it is necessary to adapt the shape of the tablet receiving portions provided at the peripheral edge portion of the rotor to the shape of tablets to be received therein. In addition, highly accurate adaptation is required for partitioning the tablets. For practical use in a tablet dispensing apparatus, it is necessary in many cases to design and manufacture in advance a tablet cassette dedicated for each particular type of tablets. Even in a large-scaled tablet dispensing apparatus equipped with many tablet feeders, it is not possible to install different types of tablet cassettes that can handle all the tablets of different types. For this reason, the tablet cassettes for frequently dispensed tablets are preferentially installed in the tablet dispensing apparatus and infrequently dispensed tablets are manually dispensed using a manual tablet dispenser.

Manual tablet dispensing, though not frequently, is complicated and time-consuming, thereby imposing large mental load on workers or operators. In order to reduce manual tablet dispensation or, hopefully, to eliminate the need of manual dispensation, such tablets that are not frequently dispensed and not usually stored in the tablet dispensing apparatus are stored in a tablet cassette, which is installed in the tablet dispensing apparatus as needed in place of an usually-installed tablet cassette. Thus, such tablet cassette is temporarily installed in the tablet dispensing apparatus. This temporary replacement of the tablet cassettes, however, has raised problems with checking of erroneous cassette replacement, etc. Attempts to develop technology for solving these technical problems have been made.

The technical problems as mentioned above will not be solved without improving the conventional techniques by which the tablet receiving portions for receiving one tablet are arranged side by side at the peripheral edge portion of the rotor and a number of tablets are stacked directly on the rotor. In the conventional techniques, the tablet cassettes dedicated for different types of tablets are required though the difference of tablets may not be large. Such tablet cassettes of different types do not produce mass production effect, thereby imposing heavy load on the design and manufacture phases. If such dedicated tablet cassettes are not ready for immediate use, it is not possible to deal with the sudden need of the dedicated tablet cassettes.

Accordingly, an object of the present invention is to provide a tablet cassette that can be commonly used for tablets of which the shapes are different to some extent.

### Solution to Problems

A tablet cassette of the present invention includes a tablet container and first and second rotors. The tablet container has a tablet receiving space therein to randomly receive a plurality of tablets and includes a bottom wall portion having an outlet port formed therein to allow the plurality of tablets received in the tablet receiving space to fall therethrough one by one. The first rotor includes a rotating shaft of which an axial line extends in a direction orthogonal to the bottom wall portion of the tablet container. The first rotor is operable to rotate around the axial line inside the tablet receiving space of the tablet container. The first rotor also includes a plurality of tablet receiving portions provided at a peripheral edge portion of the first rotor, and each of the tablet receiving portions receives one tablet to allow the tablet to pass through the outlet port. The second rotor is operable to rotate around the axial line and has one or more through holes to allow the tablets to pass therethrough in an extending direction of the axial line. The second rotor is disposed in the tablet receiving space so as to interpose the first rotor between the second rotor and the bottom wall portion of the tablet container and to leave a tablet movable space between the first rotor and the second rotor to allow the tablets, which are not received in the tablet receiving portion, to move therein. In the present invention, the number of the one or more through holes of the second rotor is smaller than the number of the plurality of tablet receiving portions of the first rotor. The through holes should be formed in the second rotor so as to extend at least in an extending direction of the axial line. Of course, the through holes may be opened radially outward.

In the tablet cassette as mentioned above, the tablet receiving space is halved into an upper receiving space and a lower receiving space by the second rotor at a position higher than the first rotor. The through holes to allow the tablets therethrough are formed in the second rotor. The number of the through holes formed in the second rotor is determined to be smaller than the number of the tablet receiving portions provided in the first rotor. This configuration means that the number of tablets to be fed onto the first rotor can be controlled by appropriately setting the number of the one or more through holes formed in the second rotor.

As mentioned above, the number of through holes to be formed in the second rotor is appropriately determined with respect to the number of the tablet receiving portions of the first rotor. If the passing ratio of the tablets discharged from the tablet receiving portions of the first rotor through the outlet port becomes close to the passing ratio of the tablets passing through the through holes of the second rotor, only a few tablets remain in the tablet movable space between the first and second rotors. As a result, the tablets stacked on the first rotor will not overlie on each other and will spread appropriately inside the tablet movable space.

As described above, since the tablets are not overlaid each other directly on the first rotor, the tablets are discharged one by one even without strictly conforming the size of the tablet receiving portions provided on the first rotor to the shape dimension of the tablets and/or providing a partition plate as in the prior art. Consequently, the first rotor of one type can be commonly used for tablets of more kinds than ever. As far as the constraints of the passing ratio of tablets are satisfied by adjusting the number of and a total opening area of the one or more through holes of the second rotor, there are no problems if a plurality of tablets are allowed to pass through the through holes during one rotation of the second rotor. Therefore, it is no longer necessary that the size of the tablet receiving portions provided at the first rotor should strictly conform to the tablets, thereby allowing the second rotor to be commonly used for tablets of more kinds than ever.

According to the present invention, a tablet cassette with a comparatively simple structure can be commonly used for tablets of more kinds than ever, thereby providing a common tablet cassette for tablets of which the shapes are different to some extent.

In a different view, it is preferred that the number of and a total opening area of the one or more through holes are determined such that the plurality of tablets, which have passed through the one or more through holes into the tablet movable space, are prevented from becoming unable to move freely inside the tablet movable space.

If the first and second rotors are fixed onto the rotating shaft to rotate at the same number of rotations, the first and second rotors can be driven for rotation with a simple structure.

If an overdrive gear mechanism or a reduction gear mechanism such as a planetary gear mechanism is disposed between the rotating shaft and the second rotor, the first and second rotors can rotate at different numbers of rotations. As a result, in addition to the number of and the total opening area of the through holes, the number of rotations of the second rotor can be used as a parameter for adjusting the number of tablets to remain or stay in the tablet movable space.

If an angle formed by the axial line of the rotating shaft and a virtual vertical line crossing the axial line is set to larger than 0 degrees (up to 60 degrees), the first and second rotors can be inclined with respect to the vertical line. With this setting, the relative direction of the top surfaces of the first and second rotors and the gravity varies as the rotating shaft rotates, thereby shaking the tablets on the first and second rotors to cause them to efficiently get into the through holes and the tablet receiving portions.

When the outlet port provided in the bottom wall portion of the tablet container is positioned upward from a point of intersection of the axial line and a virtual vertical line passing through the center of the outlet port, if the tablets temporarily stack in the tablet receiving portions of the first rotor, such stacking is unstable and upper tablets will definitely tumble down when the tablet receiving portions of the first rotor arcuately move upward as the rotating shaft rotates. Therefore, although common use of the tablets cassettes for tablets of different shapes is increased with a comparatively simple structure, the tablets can sequentially be discharged with high efficiency and stability.

The tablet container may be constituted from a first divided container and a second divided container. The first divided container includes the bottom wall portion and contains the first rotor. The second divided container is configured to complete the tablet receiving space when combined with the first divided container. In this configuration, it is preferred that a first gear is fixed onto an end portion of the rotating shaft that projects outward from the bottom wall portion; that a driven shaft is rotatably supported inside the first divided container and extends along a virtual vertical line passing through the first gear; and that a second gear is fixed onto one end of the driven shaft to mesh with the first gear. If the tablet container is constituted from the first and second divided containers, when the second divided container is removed, a portion below the second rotor can be cleaned easily.

In the above-mentioned configuration, it is preferred that a tablet guide path having the outlet port at one end thereof is formed inside the first divided container; and that the tablet guide path comes into communication with an extended tablet guide path provided in a tablet feeder and a drive shaft provided at a drive portion of the tablet feeder comes into connection with the other end of the driven shaft when the first divided container is mounted on the drive portion of the tablet feeder. This configuration is compatible with the conventional tablet cassettes. Therefore, the tablet cassettes of the present invention can be used as replacement cassettes for the existing tablet feeders and tablet dispensing apparatuses.

In the tablet cassette of the present invention, protrusions may be provided on an upper end face of the first rotor and each of the protrusions is at a position between two adjacent tablet receiving portions arranged in a circumferential direction and radially inward from the tablet receiving portions. With such protrusions, stirring effect can be expected for the tablets located inward from the peripheral edge portion of the first rotor when the first rotor rotates. At the same time, dispersing effect can be expected for the tablets located in the vicinity of the tablet receiving portions.

### BRIEF DESCRIPTION OF DRAWINGS

FIGS. 1A to 1D illustrate a structure of a tablet cassette according to Embodiment 1 of the present invention. Specifically, FIGS. 1A and 1B are perspective views of an external appearance of the tablet cassette of Embodiment 1. FIG. 1C illustrates a longitudinal cross section of the tablet cassette of Embodiment 1. FIG. 1D is a perspective view of the longitudinal cross section.

FIG. 2A is an exploded perspective view of the tablet cassette of Embodiment 1. FIG. 2B is a perspective view of an external appearance of the first rotor and the rotating shaft of Embodiment 1.

FIGS. 3A to 3C are perspective views of the first and second rotors and the bottom wall portion, illustrating the operating states in time series.

FIG. 4 is a longitudinal cross section of a tablet cassette according to Embodiment 2 of the present invention.

FIGS. 5A to 5D illustrate a tablet feeder equipped with a conventional tablet cassette. Specifically, FIG. 5A is a side view of an external appearance of the tablet feeder wherein the tablet cassette is mounted on the drive portion. FIG. 5B is a longitudinal cross section of the tablet feeder wherein the tablet cassette is removed from the drive portion. FIG. 5C is a laterally cross section of the main part of the tablet cassette. FIG. 5D is a longitudinal cross section of the main part of the tablet cassette containing tablets.

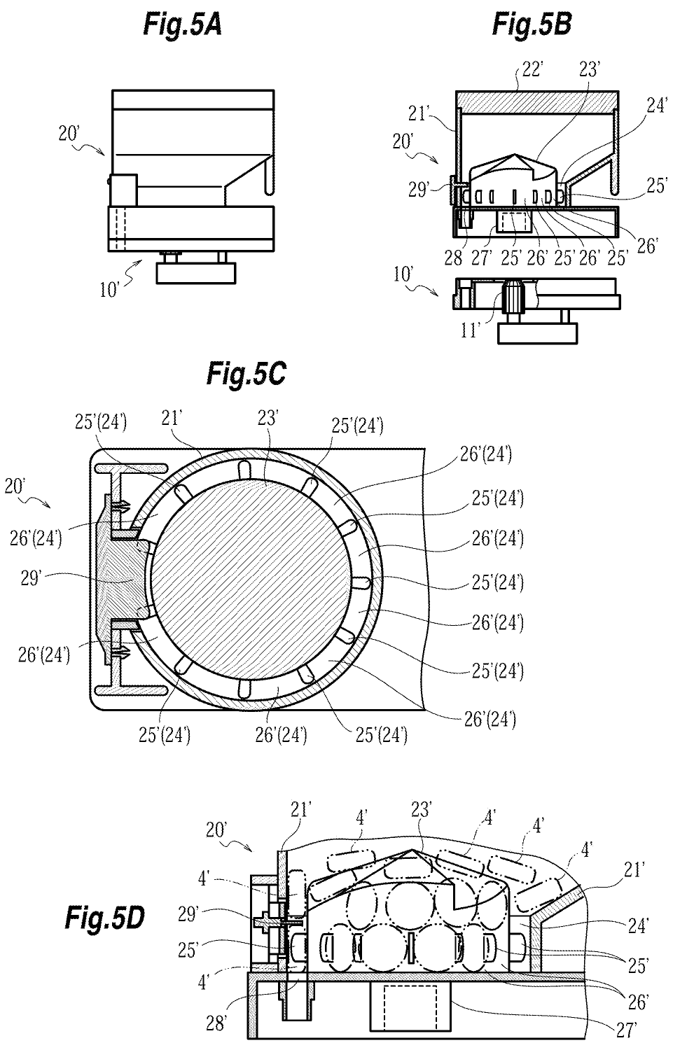

### DESCRIPTION OF EMBODIMENTS

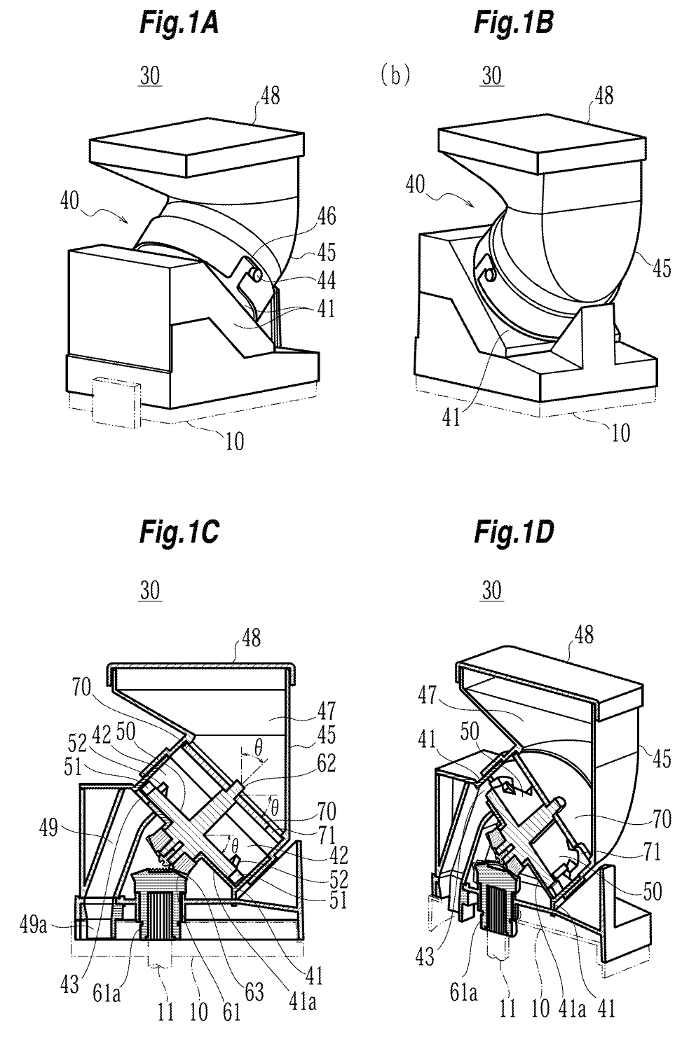

Referring to FIGS. 1 to 4, the specific embodiments of a tablet cassette according to the present invention, Embodiment 1 and Embodiment 2 will be described below in detail.

For simplicity of the illustrations, detail parts including fixtures such as bolts, connectors such as hinges, electric circuits such as a motor driver, and electronic circuits such as a controller are omitted from the illustrations. In the illustrations, the focus is placed on the parts required for describing the present invention and related parts.

### Embodiment 1

Referring to the drawings, the tablet cassette of Embodiment 1 will be specifically described below. FIGS. 1A and 1B are perspective views of an external appearance of a tablet cassette 30. FIG. 1C is a longitudinal cross section of the tablet cassette 30 as longitudinally halved. FIG. 1D is a perspective view of a half portion of the longitudinally halved tablet cassette 30.

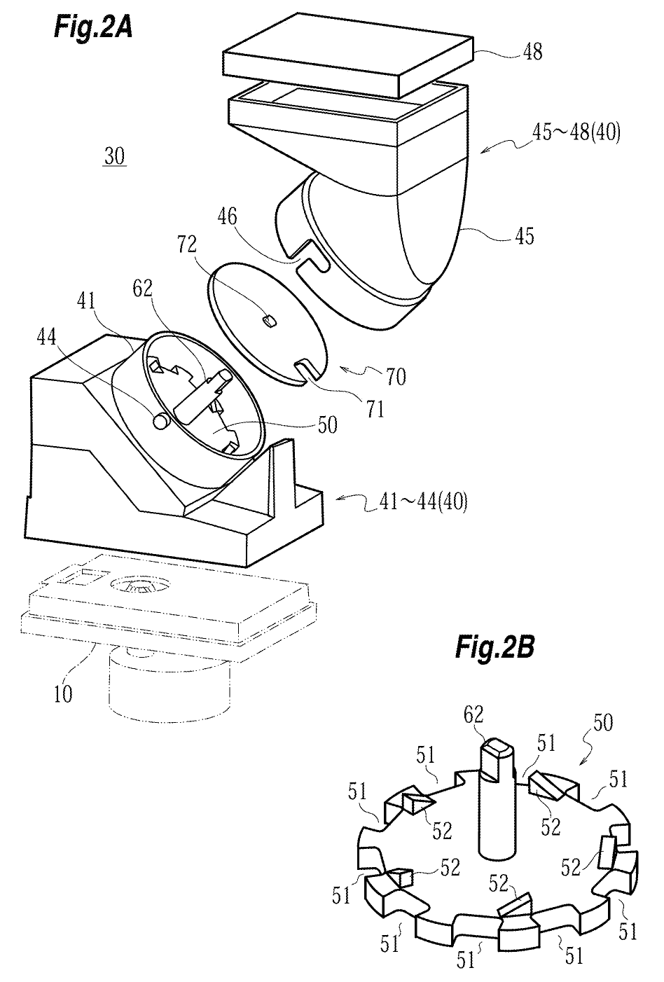

FIG. 2A is an exploded view of the tablet cassette 30. FIG. 2B is a perspective view of an external appearance of a first rotor 50 mounted with a rotating shaft 62.

The tablet cassette 30 (refer to FIGS. 1 and 2A) includes a tablet container 40 that is detachably mounted on the above-mentioned drive portion 10, the first rotor 50, the rotating shaft 62, and a second rotor 70. The first rotor 50, the rotating shaft 62, and a second rotor 70 are contained inside the tablet container 40. The first rotor 50, the rotating shaft 62, and the second rotor 70 are all together driven by means of axial rotation of the drive portion 10 when the tablet container 40 is mounted on the drive portion 10. Thus, the tablet cassette 30 of Embodiment 1 can be used for replacement for a conventional tablet cassette 20′.

The tablet container 40 is common to that of the conventional tablet cassette in the following points. First, the tablet container 40 is primarily composed of a tablet containing portion located in a central position to surround a tablet receiving space (42, 47) for randomly receiving a number of tablets. Next, the tablet container 40 has at its top end portion a lid 48 to be opened for replenishing the tablets. Further, a bottom wall portion 41a is shaped to be mountable on an upper end of the drive portion 10 as with a lower end portion of the conventional tablet cassette 20′. Still further, an outlet port 43 is formed in the bottom wall portion 41a of the tablet container 40 for allowing the tablets to fall downward from the bottom wall of the tablet receiving space (42, 47). The tablet cassette of Embodiment 1 is, however, different from the conventional tablet cassette 20′ in the following improved points.

The tablet receiving space (42, 47) surrounded by the tablet container 40 is shaped as follows: the first rotor 50 is rotatably disposed at an inner bottom of a lower portion of the tablet receiving space (42, 47); the lower portion of the tablet receiving space (42, 47) is a cylindrical space that expands not vertically but obliquely inclined at an angle θ with respect to the axial direction; the second rotor 70 is also disposed rotatably at a position obliquely upward from the first rotor 50; and at the position of the second rotor 70, the tablet receiving space (42, 47) is divided into two, a lower receiving space 42 defined between the second rotor 70 and the first rotor 50 and between the second rotor 70 and the bottom wall portion 41a, and an upper receiving space 47 defined between the second rotor 70 and the lid 48. The tablet container 40 is constituted from a first divided container 41 that surrounds the first rotor 50 and includes the bottom wall portion 41a, and a second divided container 45 that surrounds the second rotor 70. Since an upper end portion of the first divided container 41 can be fitted with a lower end portion of the second divided container 45, the second divided container 45 can be attached to and detached from the first divided container 41. In attaching the second divided container 45 to the first divided container 41, a projecting piece 44 of the first divided container 41 is inserted into a notch 46 of the second divided container 45 and then the second divided container 45 is turned to fix the first divided container 41 to the second divided container 45. In the first divided container 41, a tablet guide path 49 is formed to have the outlet port 43 at one end thereof. When the first divided container 41 is mounted on the drive portion 10 of a tablet feeder, the tablet guide path 49 comes into communication with an extended tablet guide path 49a formed in the tablet feeder. In Embodiment 1, the lower receiving space 42 works as a tablet movable space.

The first rotor 50 (refer to FIG. 2B) is a flat circular plate member. At the peripheral edge portion of the first rotor 50, a number of tablet receiving portions (in the illustrated example, there are ten tablet receiving portions) are disposed at an equidistant interval. Here, the tablet receiving portions look like notches that have been made by cutting off the edge of the circular plate member. Since only a few tablets are scattered on the first rotor 50, each tablet receiving portion 51 is sufficient to receive one tablet and allow it to pass therefrom. There is no need of partitioning the tablets vertically stacked one on another using a partition plate. Therefore, it is not necessary to have the tablet receiving portions conform exactly to the tablet shape while partitioning is necessary for the conventional tablet receiving portions 26′. For example, when dealing with circular plate-like tablets of which the shape is employed in many other tablets, about 25% allowance in both radial and thickness directions is acceptable in the present invention.

Protrusions 52 are provided on the upper end face of the first rotor 50 and each of the protrusions 52 is located at a position between two adjacent tablet receiving portions 51, 51 arranged in a circumferential direction and radially inward from the tablet receiving portions 51. In the illustrated example, the protrusions 52 are each made of a small triangular plate member. The protrusions 52 are provided at every other position not at each position between two adjacent tablet receiving portions 51, 51. Referring to FIGS. 1 and 2A, the first rotor 50 is mounted on the top surface of the bottom wall portion 41a of the first divided container 41 of the tablet container 40. Thus, the first rotor 50 is contained in an inner bottom portion of the lower receiving space 42 of the tablet receiving space (42, 47) such that the first rotor 50 is axially rotated by means of rotation of the rotating shaft 62 vertically extending to pierce the inner bottom portion at the center of the inner bottom portion.

A first gear 63 is fixed onto an end portion of the rotating shaft 62 that projects outward from the bottom wall portion 41a of the first divided container 41. A driven shaft 61a is rotatably supported inside the first divided container 41 and extends along a virtual vertical line passing through the first gear 63. A second gear 61 is fixed onto one end of the driven shaft 61a to mesh with the first gear 63. When the first divided container 41 is mounted on the drive portion 10 of the tablet feeder, a driving shaft 11 provided at the drive portion 10 is connected with the other end of the driven shaft 61a. The driving shaft 11 and the rotating shaft 62 are connected via the first gear 63 and the second gear 61 that are bevel gears such that the shafts are axially rotatable.

Referring to FIGS. 1 and 2, the rotating shaft 62 is operable to transmit a driving force generated by axial rotation of the drive portion to not only the first rotor 50 but also the second rotor 70 that is described later. In Embodiment 1, the rotating shaft 62 is disposed such that an angle θ formed by the axial line of the rotating shaft 62 and a virtual vertical line crossing the axial line is 45 degrees. The rotating shaft 62 extends vertically to pass through the center of the first rotor 50. An upper end portion of the rotating shaft 62 is inserted into a through opening 72 formed in the center of the second rotor 70 to support the second rotor 70 such that the second rotor 70 is axially rotatable. In the illustrated example, the rotating shaft 62 is integral with the first rotor 50, but they may be separate members to be assembled together. An internal gear formed by engraving from a lower end of the driven shaft 61a is operable to mesh with an external gear of the driving shaft 11 to transmit a driving force of axial rotation, as with the conventional rotating shaft 27′ mentioned earlier.

The second rotor 70 is a flat circular plate member. At the peripheral edge portion of the second rotor 70, a few through holes 71 (in the illustrated example, there is only one through hole) are formed to be opened radially outward and to allow the tablets to pass therethrough in an extending direction of the axial line of the rotating shaft 62. The number of the through holes 71 and the total opening area of the through holes 71 are determined such that a plurality of tablets, which have passed through the through holes 71 into the lower receiving space 42 (the tablet movable space), are prevented from becoming unable to move freely inside the lower receiving space 42. The second rotor 70 is disposed upward from the first rotor 50 in the tablet receiving space (42, 47), and is supported by the rotating shaft 62 extending upward from the first rotor 50 such that the second roto 70 is axially rotatable, as mentioned above. Thus, the second rotor 70 partitions the tablet receiving space (42, 47) into upper and lower portions. Namely, the tablet receiving space (42, 47) is divided into the lower receiving space 42 and the upper receiving space 47. The lower receiving space 42 and the upper receiving space 47 communicate with each other via the through hole 71.

The number of the through holes 71 formed in the second rotor 70 is smaller than the number of tablet receiving portions 51 provided at the first rotor 50. In the illustrated example, while there is one through hole 71, there are ten tablet receiving portions 51. The number of the through holes 71 is only one-tenth of the number of the tablet receiving portions 51. As with the tablet receiving portions 51, it is not necessary to have the through holes 71 conform exactly to the tablet shape, not as is necessary for the conventional tablet receiving portions 26′. More particularly, the tablets are randomly received on the second rotor 70. If there are many tablets, the tablets may stack one on another and a plurality of tablets may continuously pass through the through hole 71. If this situation occurs not so often, it is not likely that a plurality of tablets will get in the same tablet receiving portion 51 and stay there since the tablets are scattered on the first rotor 50 and the first rotor 50 rotates, being inclined. As with the tablet receiving portions 51, it is possible to let the through hole 71 have a larger allowance for the tablets than that of the conventional tablet receiving portion 26′.

The inclination of the second rotor 70 with respect to the horizontal line, that of the first rotor 50 with respect to the horizontal line, that of the axial line of the rotating shaft 62 with respect to the vertical line, and that of the axial centerline of a cylindrical portion of the tablet container 40 that surrounds the lower receiving space 42 with respect to the vertical line, namely, these inclinations are all made by the same angle θ in the same direction. When dealing with globular or elliptical tablets that readily roll, the inclination angle θ of about 10 degrees is sufficient. However, when dealing with cylindrical tablets or the like that move rolling or slide down, the inclination angle is preferably larger than that. When dealing with plate-like or square or rectangular tablets that will not move rolling or slide down, the inclination angle is preferably as large as about 30-60 degrees.

In determining the inclination angle θ, the following should be taken into consideration. As described above, the tablets on the first rotor 50 move rolling or slide down. If a plurality of tablets happen to get in one tablet receiving portion 51, the upper tablets of the stacked tablets in the tablet receiving portion may be caused to be surely rolled down out of the tablet receiving portion by shaking the tablets as the inclined first rotor 50 axially rotates. Specifically, the tablet receiving portion 51 follows an arc inclination path in association with the axial rotation of the first rotor 50 and the tablets in the tablet receiving portion 51 are shaken by means of varying gravity or the like and are caused to roll down out of the tablet receiving portion 51. Thus, the inclination angle θ is set to about 20-60 degrees. When the first rotor 50 axially rotates in such inclined state, the tablet receiving portions 51 move, depicting a locus of an inclined circle. Since such movement includes vertical motion components, the tablet receiving portions 51 move up and down. The outlet port 43 is formed at a portion of the bottom wall portion 41a of the tablet container that is directly opposed from below to one of the tablet receiving portions 51 that has moved most upward in the above-mentioned up and down movement (in the illustrated example, the highest position to which the one tablet receiving portion has reached). The outlet port 43 formed in the bottom wall portion 41a is positioned upward from a point of intersection of the axial line of the rotating shaft 62 and a virtual vertical line passing through the center of the outlet port 43.

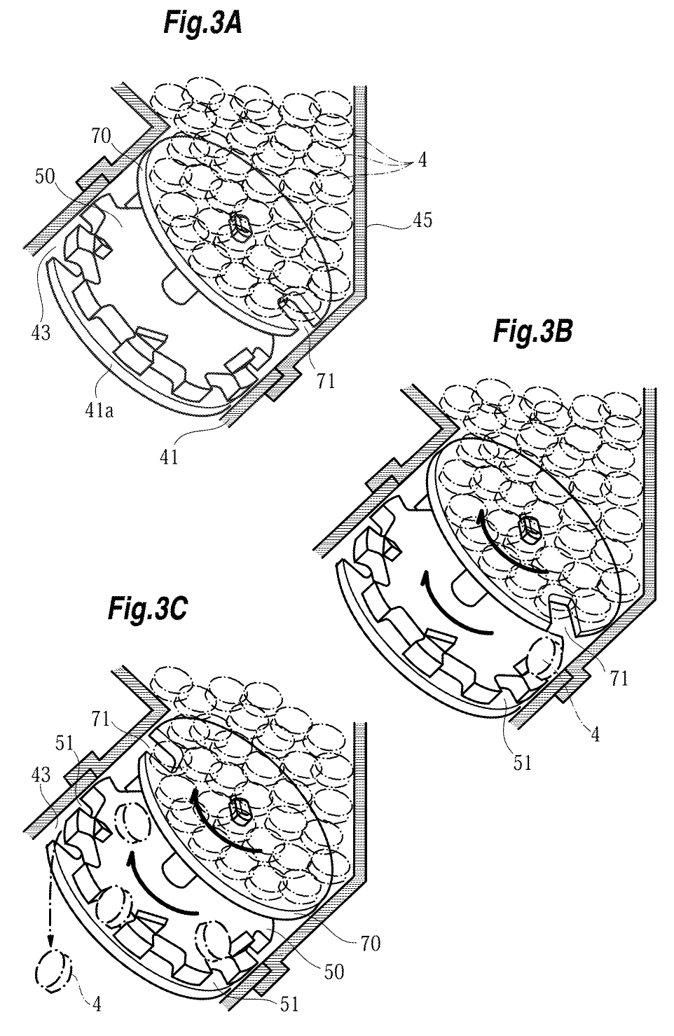

Next, referring to the drawings, the usage and operations of the tablet cassette 30 of Embodiment 1 will be described below. FIGS. 3A to 3C are perspective views of the first rotor 50 and the second rotor 70 and the bottom wall portion 41a, illustrating the operating states in time series.

Here, tablets 4 are sequentially fed by using the tablet cassette 30. If there is a cassette 30 in which a sufficient number of tablets 4 are contained, that tablet cassette is used. If not, an available empty tablet cassette 30 should be chosen. A worker or an operator should choose an empty tablet cassette 30 that satisfies the following requirements. The primary requirements for choosing a tablet cassette are: one or more through holes 71 formed in the second rotor 70 and the tablet receiving portions 51 provided at the first rotor 50 should be larger in size by about 0.5 mm or by about 25% than the outer dimension of the tablet 4; and the inclination angle θ of the first rotor 50 and the second rotor 70 should be about 30 to 60 degrees (in the illustrated example, about 45 degrees) suitable for circular plate-like tablets that are likely to slide down.

After an empty tablet cassette has been chosen, the worker opens the lid 48 of the empty tablet cassette 30 and supplies a number of tablets 4, which are more than planned to use, into the upper receiving space 47 of the tablet cassette 30, and then closes the lid 48. Thus, replenishment of the tablets is completed and the tablet cassette 30 gets ready for use. At this moment (refer to FIG. 3A), most of the tablets 4 stay in the upper receiving space 47 located above the second rotor 70. There are no tablets or very few tables that pass through the through hole 71 to fall down on the first rotor 50. If any, the fallen down tablets will stay at a lower portion of the first rotor 50 that is located obliquely below the outlet port 43 and is most distant from the outlet port 43. It is unlikely that the tablets will undesirably be discharged.

After the tablets have been replenished, the worker mounts the tablet cassette 30 on the drive portion 10 of an automatic dispensing apparatus such as a tablet dispensing apparatus and a tablet cutter for halving the tablets. Thus, the drive portion 10 and the tablet cassette 30 are operable as a tablet feeder. Then, the worker sets dispensation data to a control section of the automatic dispensing apparatus such that the tablets 4 may be sequentially supplied from the tablet feeder and be sequentially fallen down and discharged. The dispensation data may be prepared manually or automatically based on prescription data or the like. Thus, the automatic dispensing apparatus gets ready for sequential supply of the tablets 4.

In this way, the automatic dispensing apparatus is started. Under the control of the automatic dispensing apparatus, the tablet feeder is operated. The driving shaft 11 of the drive portion 10 axially rotates, which causes the rotating shaft 62 of the tablet cassette 30 to start axially rotating. In association with this, the first rotor 50 and the second rotor 70 are started to axially rotate. As the second rotor 70 axially rotates, the through hole 71 moves on a circular locus and comes right below one of a number of tablets 4 that are received in the upper receiving space 47. If the one tablet 4 is escaped from the constraints of other tablets, that tablet 4 passes through the through hole 71 to fall into the lower receiving space 42 (refer to FIG. 3B).

At this moment, there are few through holes 71 (in the illustrated example, there is only one through hole), many tablets 4 will not all together fall down. The tablets 4 intermittently fall down little by little.

The tablets 4 fallen down into the lower receiving space 42 move obliquely downward, rolling or sliding on the first rotor 50 and reach the lowermost position or get in nearby tablet receiving portions 51. There are a number of tablet receiving portions 51 (in the illustrated example, there are as many as ten tablet receiving portions) and the tablets fallen down into the lower receiving space 42 are still few. Consequently, in most cases, the tablets fallen down are likely scattered to get in different tablet receiving portions 51 one by one. Then, the tablets 4 received in the tablet receiving portions 51 are carried to the uppermost position right above the outlet port 43, following the rising part of the arc locus of the tablet receiving portions 51 as the first rotor 50 axially rotates (refer to FIG. 3C).

Some tablets may climb over other tablets that have already been received in the tablet receiving portions 51. Such tablets 4 are shaken as their attitudes in the gravity direction are varied in association with the rising movement of the tablet receiving portions 51 along the arc locus. Such tablets depart from the arc locus to roll or slide down onto the first rotor 50 before reaching the position right above the outlet port 43, thereby avoiding undesirable discharging of two tablets at one time. Thus, such tablets undergo again the process of sequential discharging, and will be carried one by one to the position right above the outlet port 43 in due course.

In the above-mentioned process, or when the tablets 4, which have passed through the through hole 71, roll or slide on the first rotor 50 to fall downward, or after the tablets 4 have fallen down, the protrusions 52 are moved to abut on the tablets as a tablet alignment disc rotates, and the tablets are then stirred. Even if some lumps of tablets 4, 4 are formed on the first rotor 50, the lumps are rapidly broken and the tablets 4 are scattered. Thus, it is rare that a plurality of tablets 4, 4 are received together in one tablet receiving portion 51 and stay there. Even if such situation should occur, it will be quickly resolved as mentioned above.

In this manner, the tablets 4, which have been carried one by one to the position right above the outlet port 43, fall downward through the outlet port 43, the tablet guide path 49 and the extended tablet guide path 49a (refer to FIG. 3C). Then, the tablets are subjected to the post processing such as dispensation or cutting.

The tablet cassette 30 that no longer contains tablets may be still mounted on the automatic dispensing apparatus if it is continuously used for another prescription. If not, the tablet cassette 30 may be removed by the worker from the drive portion 10. The removed tablet cassette 30 may be kept for future use as it is. Alternatively, if it is necessary to collect the tablets 4 or the tablet cassette should be kept empty for use with other tablets, the second divided container 45 is detached from the first divided container 41 by manipulating the tablet container 40 such that the projecting piece 44 comes out of engagement with the notch 46. Then, the second rotor 70 is removed from the rotating shaft 62. Thus, the tablet cassette 30 is disassembled (refer to FIG. 2A) for cleaning the interior of the tablet cassette. The thus cleaned tablet cassette is reassembled and kept for future use.

### Embodiment 2

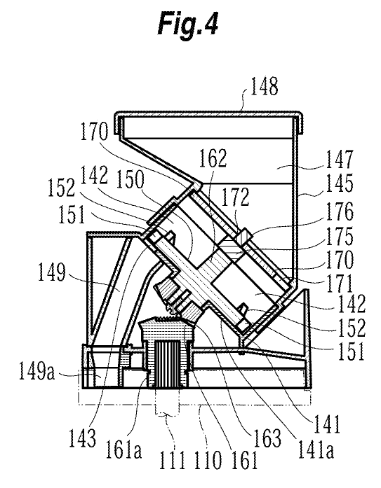

FIG. 4 is used to explain the main part of a tablet cassette 130 according to Embodiment 2 of the present invention. Parts of Embodiment 2 are allocated reference numerals obtained by adding 100 to the reference numerals allocated to the counterparts of Embodiment 1 illustrated in FIGS. 1 to 3 and the explanation thereof is omitted.

Referring to the drawings, the tablet cassette according to Embodiment 2 of the present invention will be specifically described below.

The tablet cassette 130 is different from the tablet cassette 30 of Embodiment 1 in that a planetary gear mechanism 175 is provided between a second rotor 170 and a rotating shaft 162.

FIG. 4 is a longitudinal cross section of a halved part of the tablet cassette 130. In the tablet cassette 130, an upper end portion of the rotating shaft 162 is connected with the planetary gear mechanism 175, and an output shaft 176 of the planetary gear mechanism 175 is inserted into a through opening 172. With the planetary gear mechanism 175, the first rotor 150 and the second rotor 170 can rotate at different numbers of rotations. In addition to the number of and the total opening area of the through holes 171, the number of rotations of the second rotor 170 can be used as a parameter for adjusting the number of tablets to remain or stay in the tablet movable space.

### [Other Remarks]

In the above-mentioned embodiments, circular tablets 4 are dealt with as a typical example. Regularly polygonal plate-like tablets and cylindrical capsules can be dealt with by the tablet cassette of the present invention. Further, the tablet cassette of the present invention may be used for tablets of irregular shape such as a diamond plate, spindle-shaped tablets having an expanded central portion, and halved tablets prepared by cutting a complete tablet.

### INDUSTRIAL APPLICABILITY

In addition to medicine dispensing apparatuses and tablet cutting machines, the tablet cassette of the present invention may be used for other dispensing apparatuses such as a bottling machine, provided that the apparatuses are provided with a drive portion for the mountable tablet feeder.

In addition to the automatic dispensing apparatuses, the tablet cassette of the present invention may also be used for semi-automated dispensing apparatuses in which the tablets are dealt with one by one in the manual operation.

### DESCRIPTION OF REFERENCE NUMERALS AND SIGNS

4 tablet
10 drive portion
30 tablet cassette
40 tablet container
41 first divided container
42 lower receiving space
43 outlet port
44 projecting piece
45 second divided container
46 notch
47 upper receiving space
48 lid
50 first rotor
51 tablet receiving portion
52 protrusion
θ inclination angle
61 second gear
62 rotating shaft
63 first gear
70 second rotor
71 through hole
72 through opening

1. A tablet cassette comprising:
a tablet container having a tablet receiving space therein to randomly receive a plurality of tablets; and including a bottom wall portion having an outlet port formed therein to allow the plurality of tablets received in the tablet receiving space to fall therethrough one by one;
a first rotor including a rotating shaft of which an axial line extends in a direction orthogonal to the bottom wall portion of the tablet container and operable to rotate around the axial line inside the tablet receiving space of the tablet container, and a plurality of tablet receiving portions provided at a peripheral edge portion of the first rotor, each of the tablet receiving portions receiving one tablet to allow the tablet to pass through the outlet port; and
a second rotor operable to rotate around the axial line and having one or more through holes to allow the tablets to pass therethrough in an extending direction of the axial line, and disposed in the tablet receiving space so as to interpose the first rotor between the second rotor and the bottom wall portion of the tablet container and to leave a tablet movable space between the first rotor and the second rotor to allow the tablets, which are not received in the tablet receiving portion, to move therein, wherein:
the number of the one or more through holes of the second rotor is smaller than the number of the plurality of tablet receiving portions of the first rotor.

2. The tablet cassette according to claim 1, wherein:
the number of and a total opening area of the one or more through holes are determined such that the plurality of tablets, which have passed through the one or more through holes into the tablet movable space, are prevented from becoming unable to move freely inside the tablet movable space.

3. The tablet cassette according to claim 1, wherein:
the first and second rotors are fixed onto the rotating shaft to rotate at the same number of rotations.

4. The tablet cassette according to claim 1, wherein:
an overdrive gear mechanism or a reduction gear mechanism such as a planetary gear mechanism is disposed between the rotating shaft and the second rotor such that the first and second rotors rotate at different numbers of rotations.

5. The tablet cassette according to claim 1, wherein:
an angle formed by the axial line of the rotating shaft and a virtual vertical line crossing the axial line is in a range of 0 to 60 degrees.

6. The tablet cassette according to claim 5, wherein:
the outlet port provided in the bottom wall portion of the tablet container is positioned upward from a point of intersection of the axial line and a virtual vertical line passing through the center of the outlet port.

7. The tablet cassette according to claim 1, wherein:
the tablet container is constituted from a first divided container and a second divided container, the first divided container including the bottom wall portion and containing the first rotor, the second divided container configured to complete the tablet receiving space when combined with the first divided container;
a first gear is fixed onto an end portion of the rotating shaft that projects outward from the bottom wall portion;
a driven shaft is rotatably supported inside the first divided container and extends along a virtual vertical line passing through the first gear, and
a second gear is fixed onto one end of the driven shaft to mesh with the first gear.

8. The tablet cassette according to claim 7, wherein:
a tablet guide path having the outlet port at one end thereof is formed inside the first divided container; and
the tablet guide path comes into communication with an extended tablet guide path provided in a tablet feeder and a drive shaft provided at a drive portion of the tablet feeder comes into connection with the other end of the driven shaft when the first divided container is mounted on the drive portion of the tablet feeder.

9. The tablet cassette according to claim 1, wherein:
protrusions are provided on an upper end face of the first rotor and each of the protrusions is located at a position between two adjacent tablet receiving portions arranged in a circumferential direction and radially inward from the plurality of tablet receiving portions.

10. The tablet cassette according to claim 2, wherein:
the first and second rotors are fixed onto the rotating shaft to rotate at the same number of rotations.

11. The tablet cassette according to claim 2, wherein:
an overdrive gear mechanism or a reduction gear mechanism such as a planetary gear mechanism is disposed between the rotating shaft and the second rotor such that the first and second rotors rotate at different numbers of rotations.

12. The tablet cassette according to claim 2, wherein:
protrusions are provided on an upper end face of the first rotor and each of the protrusions is located at a position between two adjacent tablet receiving portions arranged in a circumferential direction and radially inward from the plurality of tablet receiving portions.

13. The tablet cassette according to claim 3, wherein:
protrusions are provided on an upper end face of the first rotor and each of the protrusions is located at a position between two adjacent tablet receiving portions arranged in a circumferential direction and radially inward from the plurality of tablet receiving portions.

14. The tablet cassette according to claim 4, wherein:
protrusions are provided on an upper end face of the first rotor and each of the protrusions is located at a position between two adjacent tablet receiving portions arranged in a circumferential direction and radially inward from the plurality of tablet receiving portions.

15. The tablet cassette according to claim 5, wherein:
protrusions are provided on an upper end face of the first rotor and each of the protrusions is located at a position between two adjacent tablet receiving portions arranged in a circumferential direction and radially inward from the plurality of tablet receiving portions.

16. The tablet cassette according to claim 6, wherein:
protrusions are provided on an upper end face of the first rotor and each of the protrusions is located at a position between two adjacent tablet receiving portions arranged in a circumferential direction and radially inward from the plurality of tablet receiving portions.

17. The tablet cassette according to claim 7, wherein:
protrusions are provided on an upper end face of the first rotor and each of the protrusions is located at a position between two adjacent tablet receiving portions arranged in a circumferential direction and radially inward from the plurality of tablet receiving portions.

18. The tablet cassette according to claim 8, wherein:
protrusions are provided on an upper end face of the first rotor and each of the protrusions is located at a position between two adjacent tablet receiving portions arranged in a circumferential direction and radially inward from the plurality of tablet receiving portions.

19. The tablet cassette according to claim 10, wherein:
protrusions are provided on an upper end face of the first rotor and each of the protrusions is located at a position between two adjacent tablet receiving portions arranged in a circumferential direction and radially inward from the plurality of tablet receiving portions.

20. The tablet cassette according to claim 11, wherein:
protrusions are provided on an upper end face of the first rotor and each of the protrusions is located at a position between two adjacent tablet receiving portions arranged in a circumferential direction and radially inward from the plurality of tablet receiving portions.
